(19) United States
(12) Patent Application Publication
(10) Pub. No.: US 2014/0330729 A1
(43) Pub. Date: Nov. 6, 2014

(54) PAYMENT PROCESSING USING BIOMETRIC IDENTIFICATION

(71) Applicant: Patrick Colangelo, Cambridge, MA (US)

(72) Inventor: Patrick Colangelo, Cambridge, MA (US)

(21) Appl. No.: 13/886,950

(22) Filed: May 3, 2013

(51) Int. Cl. G06Q 20/40

(52) U.S. Cl. CPC G06Q 20/40145; G06Q 20/4012
USPC 705/72

(57) ABSTRACT

Facial recognition is used to associate, organize, identify, select, execute, and transfer payment, data files, and personal information to and from a user's profile in the cloud through a C2C and B2C network. The information—financial, professional, and personal—is securely delivered to a POS system, to a credit-card company/acquirer, to a cloud database, to a checkout tablet, and/or to a consumer-owned and operated smartphone device or tablet.

### TECHNICAL FIELD

In various embodiments, the present invention relates to payment processing and cloud computing using a biometric identification system.

### BACKGROUND

Existing payment processing and other end-user financial payment systems rely on items such as credit cards and smartphones. Credit card transactions, however, are susceptible to fraud, and credit cards may be a hassle to carry and monitor; smartphone-based transactions at point-of-sale (“POS”) terminals suffer low adoption rates and technical difficulties. Furthermore, a means to quickly and reliably transfer contact information between two people without manually entering in the details does not exist. A need therefore exists for a payment and sharing system and method that does not require the payee or user to have a secondary payment device (e.g., a plastic card, smartcard, or smartphone).

### SUMMARY

In general, various aspects of the systems and methods described herein include dynamic payment and user-information sharing via facial recognition, without requiring any secondary payee device. A quicker, simpler, and more thorough process is facilitated via facial recognition and via instant contact-card sharing from the cloud, without the need for two devices or manual toil. Media files, documents, and other identification materials for users and/or public entities may be transferred and/or displayed in the same way.

In various embodiments, the present invention a) operates an identification, selection, and redemption system for consumer-related financial information and for user-related personal information and media; b) eliminates or reduces fraud from payment transactions and data transfers using the combination of intelligent biometrics, secondary security measures, and an instant notification system; c) integrates a payment-selection system and data storage, selection, and transfer systems; d) employs advanced measures to reduce the time-to-match to seconds and increases the accuracy-of-match to 100% for live-image facial recognition identification; and/or e) codifies a social-media grid matted in personal and financial tool kits that are embedded and actively executed through real-time transaction parsing. With regard to payment, embodiments of the present invention match a user's live image at POS against profile picture(s) (located, e.g., remotely and/or in the cloud) to pull up financial details, list payment options differently on a per-transactional basis through customizable order and style, ensure fraud preclusion through preventative measures that take effect from as early as sign-up to as late in the transaction as visual confirmation at POS and email notification to address on file as receipt; integrate proprietary record gleaning system to parse, select, and upload transaction data in real-time after a purchase to the user's social profile; implement unique reduction-in-user-pool commands; employ a face-PIN combination on a floating match threshold for 100% match levels; and/or uniquely desegregate consumer data with specific merchant and current transaction data to offer a unique payment experience to every customer using, e.g., loyalty points, coupons, gift cards, rewards, and recommendations. With regard to data transfer, embodiments of the present invention provide fast digital contact exchanges (using, e.g., the face-PIN combination) without the need for emails, manually entering in details, or even two devices; establish data in either checking vault (public) or savings vault (private), allowing users to transfer files back and forth for personalized access at login; offer users a recommendation notification system, thereby alerting users of what media files (music, videos, pictures, documents) on their device their contacts may like; and/or cultivate a private document display system for public entities using applications equipped with timers for automatic document logout.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a method for processing facial-match-based transactions in accordance with embodiments of the present invention;

FIG. 2 illustrates a screenshot of a payment option screen of a user's cloud profile in accordance with embodiments of the present invention;

FIG. 3 illustrates a payment system having loyalty, coupon, gift card, and delayed payment integration in accordance with embodiments of the present invention;

FIG. 4 illustrates a payment-option display in accordance with embodiments of the present invention;

FIG. 5 illustrates a method for information transfer from POS to server in accordance with embodiments of the present invention;

FIG. 6 illustrates a method for live image capture, facial recognition, and user-pool reduction in accordance with embodiments of the present invention;

FIG. 7 illustrates a flowchart representing an information pipeline on the server end in accordance with embodiments of the present invention;

FIG. 8 illustrates a method of social integration in accordance with embodiments of the present invention;

FIG. 9 illustrates a method for C2C and “public entity” data transfer in accordance with embodiments of the present invention;

FIG. 10 illustrates method for data-vault and data-transfer processes in accordance with embodiments of the present invention;

FIG. 11 illustrates a screenshot of three portals in a user's cloud profile in accordance with embodiments of the present invention;

FIG. 12 illustrates three levels of consumer data available to merchants in accordance with embodiments of the present invention; and

FIG. 13 illustrates a credit-card swipe process for non-system users in accordance with embodiments of the present invention.

### DETAILED DESCRIPTION

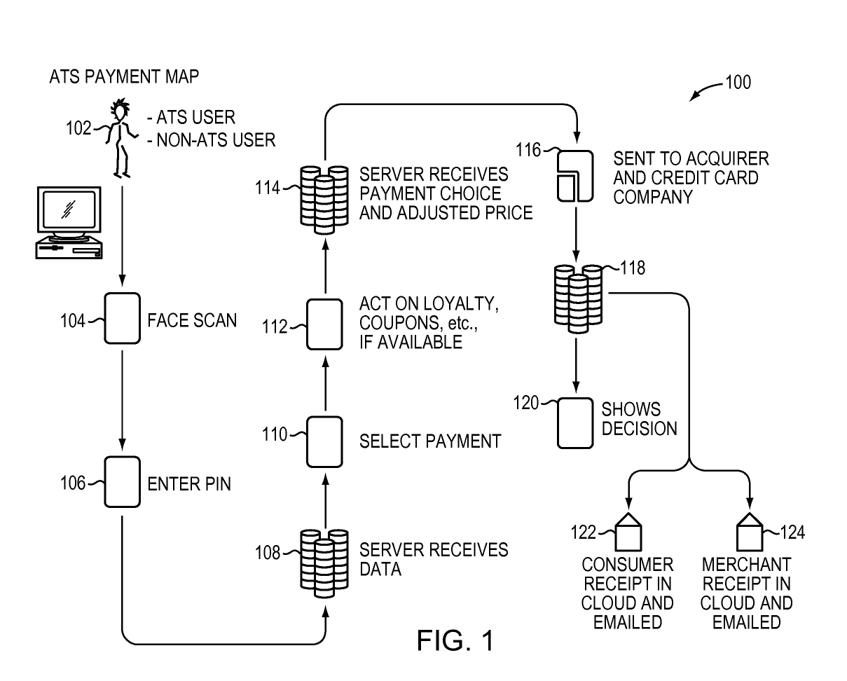

FIG. 1 illustrates one embodiment of a method 100 of a payment process for both registered and unregistered users (“payees”). The payee 102 may be checked out at POS by a cashier, checkout attendant, server, sole proprietor, or by a self-checkout machine. Once the transaction details are input into the POS and finalized, a tablet computer or other similar device (which is either connected to the POS or is the POS) displays the data (e.g., the items purchased and/or final price). At this point, the payee 102 may choose to use a plastic credit card and proceed to swipe on the detachable credit card reader or use face-based payment (step 104). The payee takes a face scan and enters his or her PIN (or other identifying password used in conjunction with the live image) (step 106). The server receives this data and pulls up the corresponding user profile (step 108). The server parses the data and extracts relevant payment information to send back to the tablet (step 110). The payee acts upon this information by selecting a payment option and other unique payment experiences (step 112). This selection and associated data is then sent back to the server (step 114), and optionally passed along to the acquirer and/or credit-card company for fraud check (116). The decision (either authorization or rejection) is sent to the server (step 118), and the server sends the decision and associated information to the tablet to display to the payee (step 120). The server may also send a digital receipt of the transaction to both the consumer (step 122) and merchant (step 124) in their respective cloud profiles and also via the email on file.

Systems implementing the method 100 of FIG. 1 may take many forms. For example, a retail system may include a tablet connected to a POS on (e.g.) a counter (the tablet may have a card swipe reader plugged into its headphone jack or other port); a tablet connected to a PIN machine and paper receipt device optional; and/or a tablet with no connected POS. A restaurant or dining system may include a tablet brought to tableside, for example, and the user may enter his or her face scan or PIN on the tablet; additional screens on the tablet may enable the user to add a tip or validate parking. A laptop or other computer-based system may include a webcam for taking a single photo or a multiple-second facial video scan that verifies if the user is a live image through tests on movement, blinking, following commands, pupil dilation, etc. The user may, in addition, verify his or her identity by entering a PIN. A system for use by a sole proprietor or other such merchant may include a smartphone or similar device.

In addition to or instead of the facial recognition systems and methods described herein, the present invention includes other methods of identification. For example, a user may scan a fingerprint (either when a selection option is tapped automatically or as an alternative to the entire face payment system to identify the user with different fingers being attributed to different cards). Other methods of biometric identification include gesture-based facial recognition to (e.g.) select payment—the user holding up one finger may signify the use of a first credit card, for example, and the user holding up two fingers may signify another card. Still other identification methods include iris scan, retina scan, palm scan, or any other method known in the art.

A user may sign up in order to download the application to their smartphone and/or tablet device. The sign-up may include the user's full name, address, contact information, demographics, employment, and/or any other pertinent identification. In one embodiment, location-based services (e.g., GPS or Wi-Fi) must be enabled on the user's phone in order to launch the application. In one embodiment, the payee/user takes a facial scan from a checkout tablet having a built-in webcam (or similar device), optionally enters his or her PIN, selects his payment choice, accepts a loyalty/coupon/gift card discount (if applicable), and gets a digital receipt via email. Details of the notification may include the name of the officer/physician/recipient, the GPS location of the transfer, the date and time stamp, and the file(s) displayed and accessed. In other embodiments, the login for the system uses just a username and password, a fingerprint scan on a touch screen, a split-second facial scan followed by PIN, and/or a multiple second facial video (to test a live image).

In one embodiment, a system for receiving and processing face payments includes (i) a checkout tablet-based computer, smartphone, laptop, or other computing device and (ii) a server (e.g., a metal-as-a-service or “MaaS” server); a network connects the tablet and server. The system may further include a POS system that may or may not be integrated into the checkout tablet, a merchant tablet operating on the merchant system that is connected to the checkout tablet, and/or a pre-existing computer system that is connected to the checkout tablet; a user's smartphone device or tablet (dubbed smartphone); a user's profile in the cloud (dubbed profile); and/or third parties including credit card companies and acquirers. The connection between the checkout tablet and POS, and/or between the checkout tablet and paper receipt device, may be a wireless or wired connection. A user and/or merchant profile in the cloud may be accessible using a consumer and/or merchant app on the smartphone and/or tablet, online via laptop or desktop computer, or on any device having an internet connection and access.

The system may allow users to select a plurality (e.g., three) of different payment options to use for any one purchase. When two credit cards are selected for a payment of $25, for example, a pop up screen is displayed asking how much of the purchase price to allocate to each card. As soon as the user enters in a number for one card, the other card automatically registers the balance. The system may display multiple payment options under one credit card company in various ways. For example, payment options can be listed with their last four digits displayed and the distinction of either credit or debit; as VISA 1, VISA 2; and/or with the option of credit or debit. Payment options may be displayed as a custom term or keyword (e.g., generated by the user from his or her online portal) to help the user remember each card (for example, the terms may include business, personal, shared, or the name of a bank).

The system may verify a minor's age at point of sale. Once the user is identified, payment options may not appear if (e.g.) the user is buying a tobacco product and is under the age of sixteen, an alcohol product and is under the age of 21, or a rated-R film and is under the age of eighteen.

Users may customize which payment options appear first on the payment screen by configuring their order online. In various embodiments, the most-used card is listed first, the card with the most remaining credit is listed first, the card with the largest credit allotment is listed first, or the user's preferred card is listed first. The system may also be configured never to show a credit card that is closer than a certain threshold to going over the monthly credit limit (i.e., $50) or never to show a card that will go over the credit limit if used for the transaction. Such budgeting and purchase tracking is made possible when every purchase a user makes throughout the month is made on a checkout device configured in accordance with the present invention or if the user manually fills in purchases not used on devices to keep the system up to date and accurate throughout the month.

In one embodiment, users may defer payment for up to several weeks or months at participating vendors. In exchange for this delay on payment, users may pay a premium on their purchase that is profit shared by the vendor and/or the acquirer bank. Users may select this option by selecting a “put it on my tab” (or similar) option at the payment screen to thereby delay payment for up to several weeks or months.

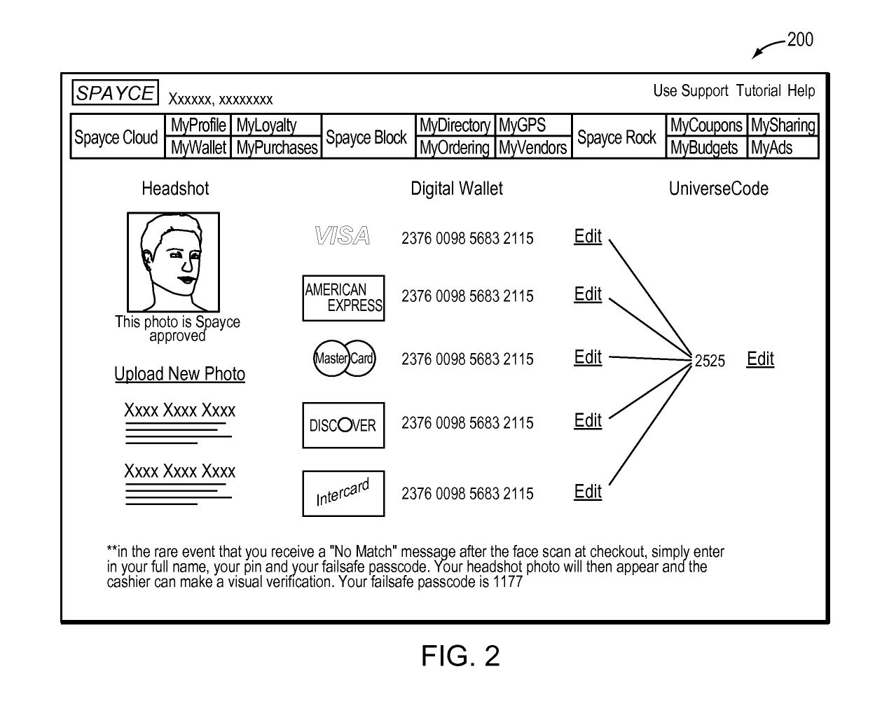

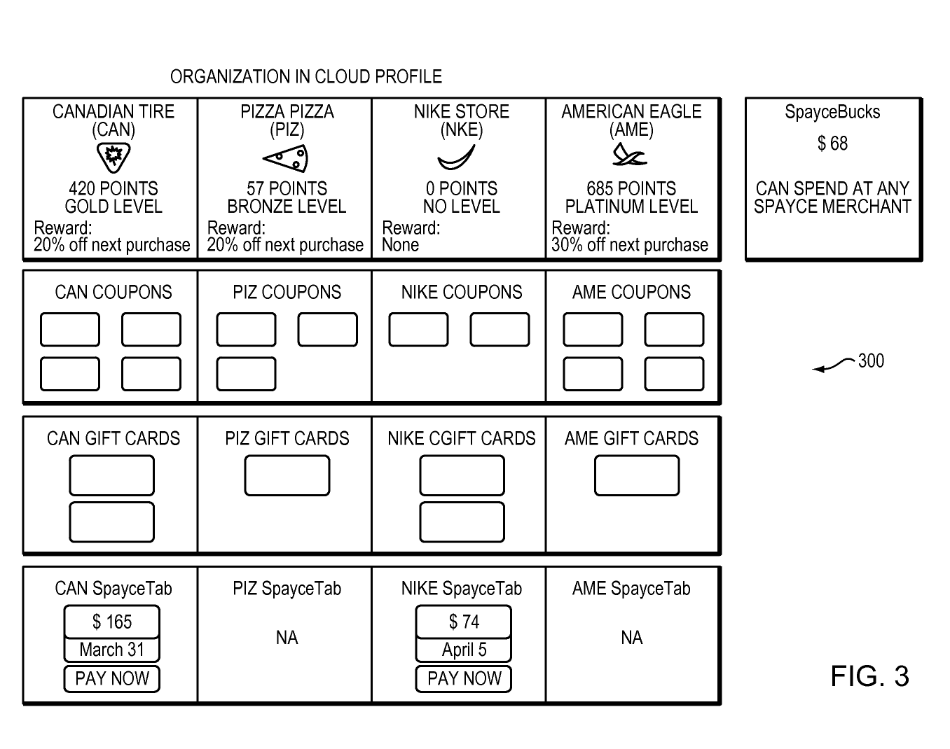

FIG. 3 illustrates one embodiment 300 of a display of a computer screen including loyalty, coupon, and gift cards, and the delayed payment upload, selection, and redemption process. Merchants may be listed by full name, logo, and/or a merchant ID code. When a profile is matched after the face-PIN search, the server pulls up the user's payment options and/or the user's “payment experience” grid, an embodiment 200 of which is displayed in FIG. 2. The merchant ID code received from the tablet may be matched against the listed merchant ID code listed in the user's cloud profile. If there is a match, the server detects that the user has previously shopped at the given merchant. The server may select data pertaining only to that merchant ID code (i.e., one whole vertical column in FIG. 3) and send the corresponding data back to the tablet for the user to act upon. Users may automatically earn loyalty points by shopping at participating merchants, and these points may be tracked in real-time with the earning level and the corresponding reward displayed online. This reward (if any) is sent to the tablet; the user may choose whether to use it or not. In another embodiment, rewards are used automatically unless otherwise specified by the user in the options tab of his/her online profile.

Coupons may be uploaded to the online profile via any suitable method, such as via QR code scan, for both paper and digital form. Each QR code contains the merchant ID code and the item ID code (which is a short identification code for each product a participating merchant sells). The item ID code may be a new ID made exclusively for the system for each product in inventory, or an existing code used in the merchant's POS. The server receives the item ID codes when the tablet sends the merchant ID code and transaction price and matches the ID codes against any unexpired, uploaded coupons for the merchant that contain the specific item ID codes. These coupons may be either automatically redeemed or, in another embodiment, are sent to the tablet for the user to act upon. When clicked on, each coupon displays its details, its item ID code, and/or its expiry date; users may view recent coupons, expired coupons, and redeemed coupons in their online profile. In one embodiment, the present invention includes an online marketplace in which users may buy and sell coupons, loyalty rewards, virtual currency, and/or gift cards. A commission may be charged on some or all C2C transactions and transactions may be brokered through its platform. Gift cards may be purchased either from a C2C marketplace or may be uploaded via QR code scan from plastic or digital form. Any uploaded gift cards for the merchant may be matched by the merchant ID code and sent to the tablet along with the other payment options as an alternative payment option. The user's delayed payment program for the specific merchant may also be analyzed to ensure the limit is not passed (i.e., a maximum of two concurrently held delayed payments for a single merchant). If this limit has not been passed, the option may be available as a secondary payment option in an embodiment. A loyalty rewards program applicable at all merchants may be sent to the tablet as an alternative payment option as well.

The mobile application may include a QR code (or similar code) scanner that uploads loyalty cards and coupons to the cloud when scanned. For self-checkout, this same mobile scanner may be used to scan all QR codes on tagged merchandise in participating vendor stores. When a code is scanned, the product may be launched on the smartphone app displaying (e.g.) its name, price, photo, and other optional information like a video, written description, photo album, and similar items. Users may pay instantly with one of their linked cards from their digital wallet. When they are ready to leave, users may check in with an attendant or cashier to get a bag and take off any alarm tags. At this point, the employee may verify the purchase from the digital receipt on the master tablet.

Loyalty for each vendor may be accrued automatically as a result of purchases made. All loyalty points and/or data may be organized in the user's profile in the cloud. Loyalty is separated by vendor in the profile and is viewable at any time. The system may send email notifications out to users when loyalty is ready to be redeemed for rewards. When loyalty is ready to be redeemed for a reward, it may automatically appear on the checkout screen and the reward/discount may be instantly redeemed. Users may configure loyalty settings for all or specific vendors based on when to use loyalty points to redeem rewards and when to continue saving them. A keyword of a vendor name may match a keyword on a user's profile that has separated merchant-specific loyalty. When the user is identified, the loyalty profile may be pulled up, and using keyword match, the user's loyalty for that specific vendor is sent to the tablet, factored into the price, and displayed on the checkout screen.

Users may scan the QR code on coupons for any participating vendor with their smartphone (or other device) to upload them. The system may automatically upload all coupons scanned by a user's smartphone to his profile in the cloud and organize them according to vendor name. The details of all coupons may be viewed in the cloud, either online or on their smartphone app. Users may see expired coupons, redeemed coupons, and active coupons on their profile in the cloud. The system may automatically redeem all applicable coupons to the purchase based on, for example, vendor-name keyword match and product keyword match. Applicability may be determined based on the coupon still being active (i.e., not having expired), the vendor keyword for the coupon matching the vendor keyword for the transaction (being for the specific vendor), and/or the coupon keyword matching the product keyword (being for the specific product being purchased). A keyword representing a vendor name may match a keyword of vendor coupons on cloud-based profile. Then keywords of each active coupon for that vendor are matched against the keywords of the products being purchased. The rewards and discounts may be automatically factored in. Alternatively, redemption of active coupons for the vendor may be done manually, with the customer selecting relevant ones displayed on the screen. For the coupon automatic redemption of individual products, a list of product keywords for items being purchased may be displayed either on the checkout screen and thereafter sent to the server for matching, or may come from the vendor's POS computer to the checkout tablet and then to the server without being displayed on the tablet screen.

Gift cards may be purchased or sold in (e.g.) an online mall. The gift cards may have a QR code on them that may be scanned using, e.g., an application on a user's smartphone. When scanned, the system may automatically upload the gift card to the user's profile in the cloud and organize it according to, e.g., vendor name. Each gift card may have a vendor name keyword associated with it; when the vendor name keyword is sent to tablet and then to server (i.e., the system obtains a trigger and parses it to get transaction details including vendor name), the keyword match takes place and the gift card is either automatically redeemed and applied to the purchase price or appears as a payment option on the payment selection screen. The vendor gift card may display a number on the inside of its logo representing how much cash it carries.

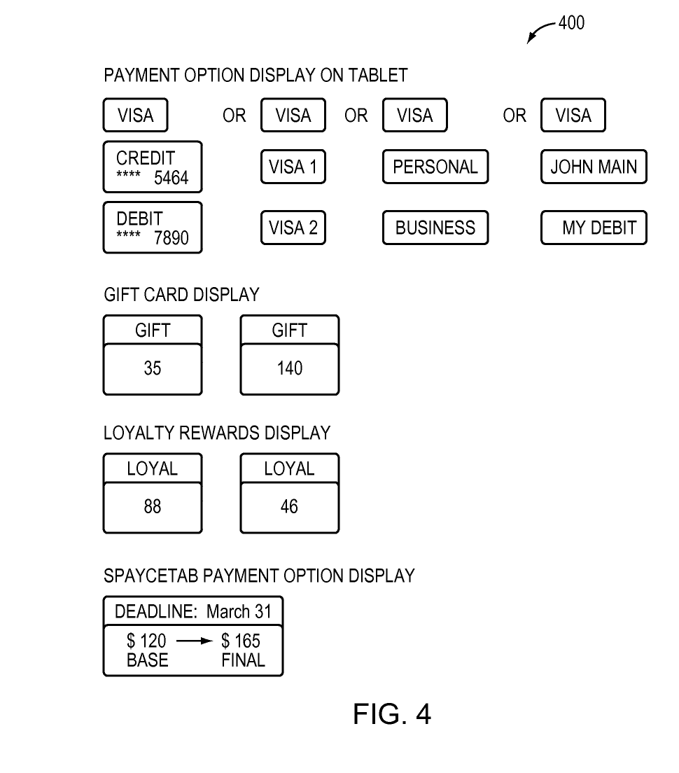

FIG. 4 illustrates one embodiment 400 of a customizable payment option display on a tablet or similar computing device. Payment options may be listed by their full credit card number, by the credit or debit distinction, by numbered distinction of the credit card brand, by the purpose of the card, and/or by a customized name made by the user. The gift card display on the tablet for a specific merchant may be displayed as an alternative payment option with a number inside representing how many dollars it carries. The loyalty card may also be displayed in this manner; the delayed payment displays current transaction price, final transaction price after interest, and the deadline for delayed payment.

A virtual currency may be used and may turn into real cash, rewards, prizes, or similar real-world goods or services when redeemed. A virtual-currency card may be displayed on the checkout tablet screen, among other payment options, when loyalty has been accumulated enough to redeem the virtual currency for cash. The virtual-currency digital card may be used like any typical gift card, and users may use it at any participating vendor. The virtual-currency digital card may display a number on (e.g.) the inside of its logo representing how much cash it carries. Besides serving as a real payment method, the virtual currency may be used to purchase digital accessories like personalized backgrounds for their virtual-currency card or a personalized payment screen. Users may use the virtual currency to purchase more storage space in the data-storage area for sharing digital data. Users may earn credits of the virtual currency via consistent usage of the system, through completion of surveys and feedback, by opting into specific consumer data programs, by opting into location-based advertising, by sharing coupons and advertisements with friends on social-media sites, by uploading purchases, and/or by winning in online games.

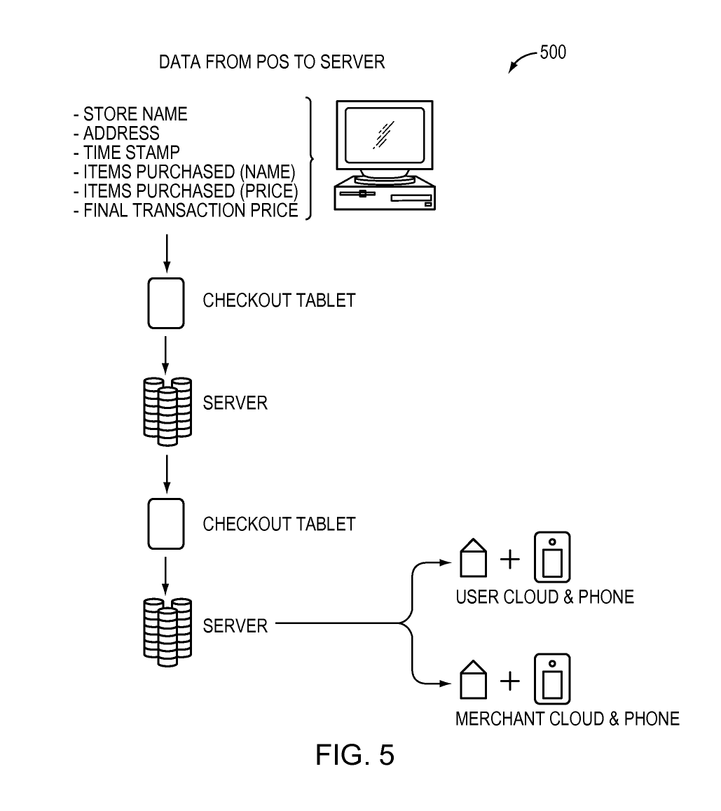

FIG. 5 illustrates one embodiment of a system 500 for information transfer from a POS system to a server. The POS sends one or more of the following data: name, address, time stamp, items purchased (names, item ID codes, prices), and final transaction price. Some of this info may be displayed on the tablet and/or sent to the server. The server may then send back payment options, loyalty rewards points (if any), coupons (if any), gift cards (if any), and/or virtual currency (if any). Upon receiving this data from the server, the user may act upon it, and the finalized transaction price and payment option may be sent to the server (and to and from the acquirer/credit card company for a decision). The data is then reformatted into a digital receipt and sent to the merchant's cloud profile and the user's cloud profile.

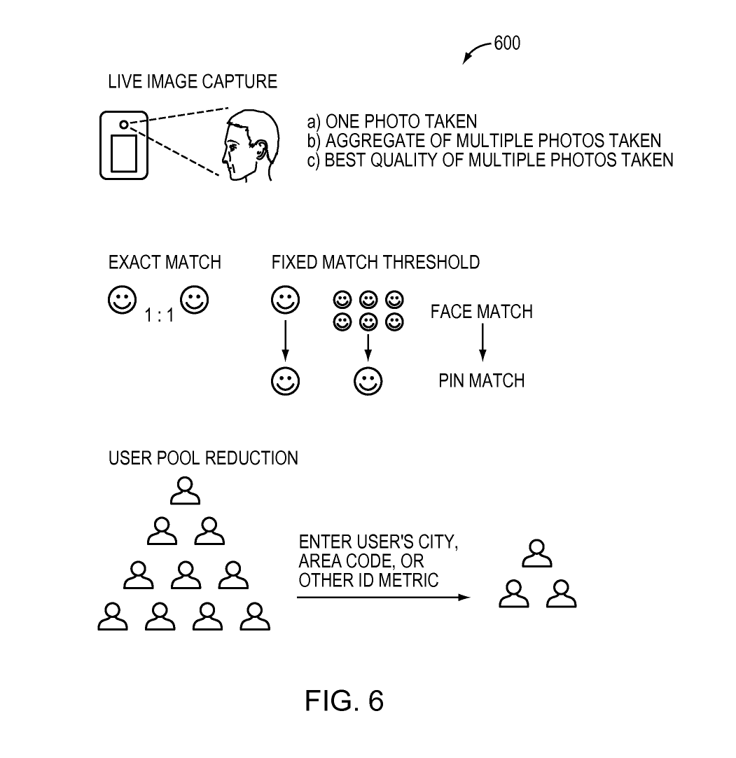

FIG. 6 illustrates one embodiment of a process 600 for live-image capture, facial recognition, and user pool reduction. The live image used to identify a user may be a single photo, an aggregate photo of multiple photos taken, or the best quality photo of multiple photos taken. The process for facial recognition may be a 1:1 mandatory match or a fixed match threshold (i.e., a 30% match) that pulls up multiple profiles that look similar; entry of a PIN may ultimately select the exact profile from a plurality of matching profiles. The user-pool reduction embodiment allows for a much quicker match process (e.g., a few seconds) by reducing the user pool matched against through geography (i.e., by limiting the number of possible matches in accordance with the city or area code of use). In one embodiment, the user selects his or her city (as it is displayed on his online profile) or enters in his or her area code of the phone number on his or her online profile.

Fraud may be mitigated via one or more of several measures. If two users look alike, for example, their PINs remain different. As soon as a new PIN is user-generated online, the system verifies that the profile picture associated with the PIN does not resemble in any way (i.e., a 0% threshold) any other profile with a matching PIN. In addition, all users may be given a failsafe code, which serves as a back-up passcode in the event of a no-match at checkout. In the event that a no-match occurs, users may enter in their name, PIN, and/or failsafe code to gain access to their account. In other embodiments, the user's postal code and PIN-failsafe code or area code and PIN-failsafe code are used. The system may further send out a digital receipt detailing the whole transaction to the email associated with the account if, for example, a user's PIN has been compromised by an individual who is visually similar to the user, the user is thereby informed and may change his or her code immediately.

Payments may facilitate standard anti-fraud measures by credit card companies and acquirers. The decision of approval or rejection may be passed back along from the credit-card company and acquirer to the system server and thereafter sent back to tablet to be displayed on the screen. The first screening by the acquirer may be a “sanity” test for (e.g.) valid merchant ID, valid Luhn check on PAN, valid expiration date, amount field within reason for type of merchant, and/or a number of other checks. Following the first screening, a floor-limit check and a “negative file” check may be done against a file of known bad cards. A “velocity file” check may then be done to keep track of typical card usage (number of uses and total amount charged). Furthermore, during a live image capture, the cashier and/or vendor may be prohibited from viewing the live image of a user, as the entire match process all occurs on the back end secure server. All live images may be destroyed immediately after they are matched.

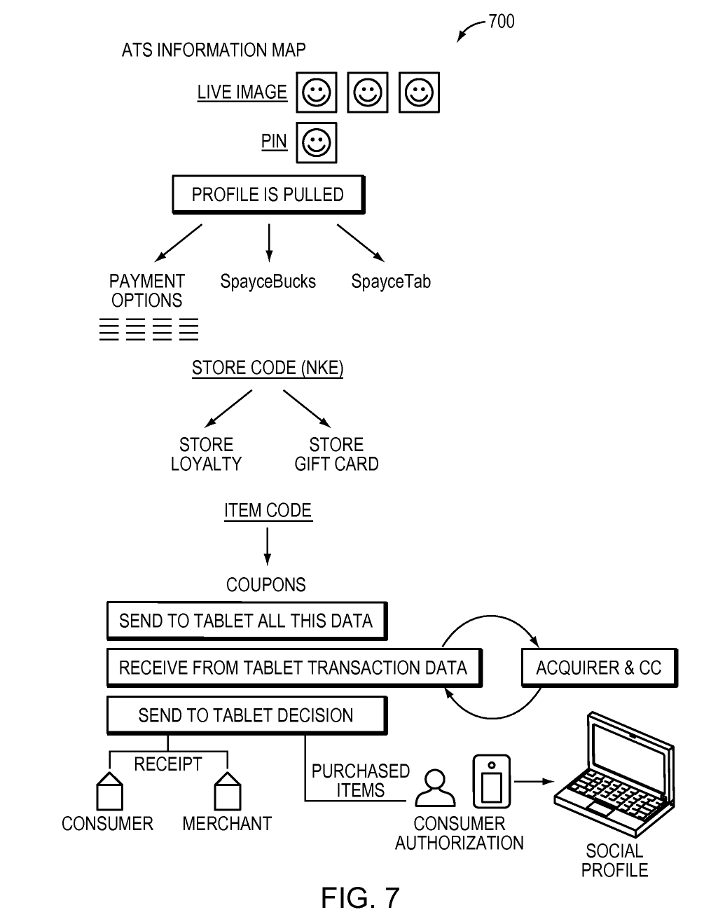

FIG. 7 illustrates one embodiment 700 of an information transfer map for payment processing on the server end. The server first receives the live image, which, under the fixed match threshold embodiment, may pull up multiple profiles. The server then receives the PIN, which selects the exact profile. Once the profile is pulled, the server parses the profile and pulls up the user's list of payment options, virtual currency (if any), and info on its tab usage. The server then receives the merchant's ID code and matches that against the user's list of participating merchants. When the exact merchant is matched, the user's store loyalty (if any), and store gift cards (if any) are also pulled. The server then receives the item ID codes and uses these codes to match against any uploaded coupons for that merchant containing those exact item ID codes. The server may send all of this data to the tablet, receive the adjusted data back from the tablet, receive the decision form the acquirer/credit-card company, and/or send the decision to the tablet. The server may then send a digital receipt to both the merchant and the user and send the purchased items (and their respective details like photos, description, etc.) to the user's social profile (but not before, in one embodiment, getting authorization from the user first via the smartphone app or cloud profile). The email that contains the receipt after a purchase may also contain suggested similar products, brands, and/or stores for the user. A digital receipt may be sent to both the merchant and consumer immediately (or soon) after each transaction. The receipt may be sent automatically to the email address listed on the user's profile in the cloud, which may be changed or configured at any time; the user need not enter in his or her email address at the POS.

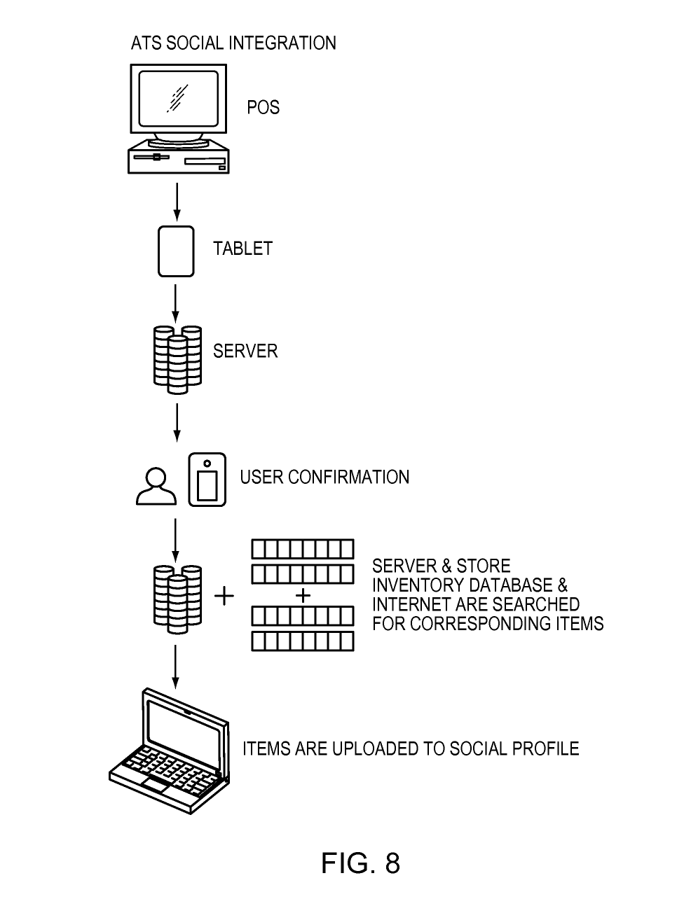

FIG. 8 illustrates one embodiment 800 of a system and method of social-media integration that maps out how the POS transfers the data of the items purchased to the tablet and thereto the server. The server may then notify the user and (in one embodiment) get authorization to automatically upload the recent purchase to his/her social profile for friends and other shoppers to see. Once authorization has been received for all, or some, of the items, these items may be run against the server's inventory database of information, the merchant's inventory database (if the system has been granted access), and/or the Internet to thereby associate a detailed information entry with the name of the product when uploading the item to the social profile.

Users may share purchases and discounts through the social-media integration system in real time with their friends via any social network. Users may comment, “like,” and recommend other purchases, as well as scour the web to find the product at a better price. In one embodiment, the more attention (or “buzz”) a post creates, the more virtual currency the user earns. Celebrities may trend and develop followers based on where they are shopping, what they have just bought, who they are with, and/or pictures of them wearing newly purchased products. Users may share any advertisement or coupon with their friends via social-media sites; the users may simply attach their username/other identifying name to the message. In one embodiment, the more users share, the more virtual currency they earn. Users may be rewarded by the amount of eyeballs that a post attracts (tracked by the system based on how many times the username appears through online impressions) and/or by a fixed reward scheme based on upfront rewards simply by posting. Simply affixing a hashtag (“#”) or other similar identifier to any message may allow the system to track the post and thereby reward the user.

Users may be allotted their own social-media profile, i.e., their own public social media profile that allows them to display in their “shopping window” items they just bought, the deals/rebates they participated in, and/or a wish list of future purchases. The social-media profile may also allow users to connect with social-media friends and with other shoppers worldwide by allowing users to “window shop” on other profiles. The social-media profile may allow users to upload all of their social-media friends, connections, and/or followers onto the platform and convert them to “shoppers.” The more shoppers a user has (i.e., friends/fans/followers), the more virtual currency the user may earn and the more popularity the user may display. Profiles may be configured to display their window to only specific friends, shoppers in their broader network, or to any user. All users may subscribe to celebrities' profiles worldwide to see what they are buying in real time and window shop on their profiles at any time (by, e.g., getting real-time feeds for celebrities). All social-media profiles may be rated on a variety of shopping characteristics, e.g., “hottest item snagger,” “best deal hunter,” and/or “most tasteful eye,” in different product categories. Users may then subscribe to different shoppers with high scores in the particular shopping categories that they share a love for (i.e., women's shoes, sports gear, etc.). Users may get real cash rewards for giving other shoppers recommendations that result in purchases. The social-media profile taps into the urge for friends to want to own something (or at least take a look at it), when they know that their friend or a celebrity has purchased it. The social-media profile hones in on this universal human curiosity by automatically uploading the product that a user has just purchased to his/her public profile in real time, by way of product keyword parsed from the checkout tablet. The user may opt out of displaying any recent purchase and may configure automatic upload settings or deactivate automatic uploads (and only upload manually) all from his online profile. Each product upload to the social-media profile may include a name, description, price, location bought, merchant name, and/or photos. Users are encouraged to upload photos of themselves wearing or using the product, as well. Each post may have comments associated with it, ratings, likes, and/or sharing links, and each profile may be viewed as an actual shopping window, completely customizable by the user.

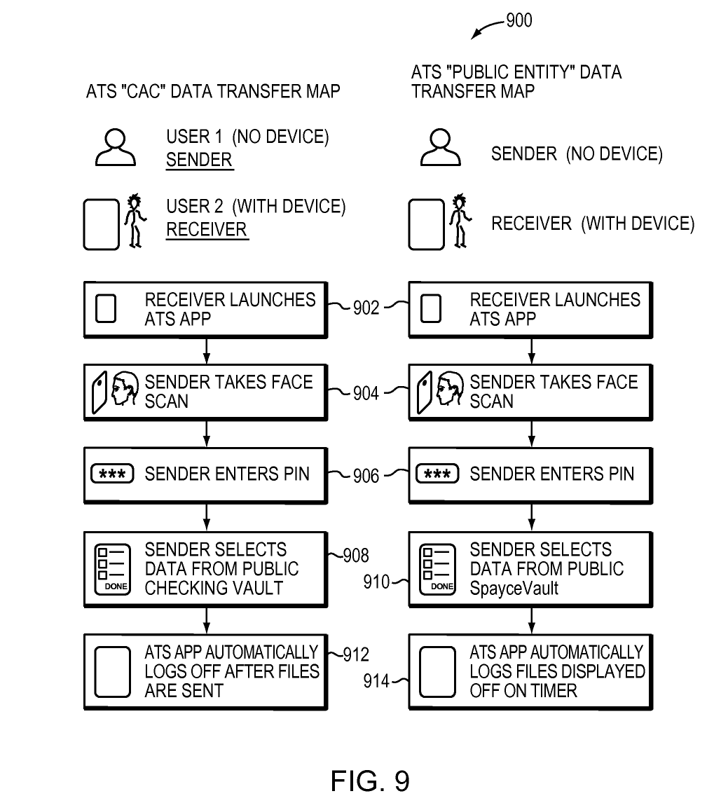

FIG. 9 illustrates one embodiment 900 of a C2C data transfer map and a “public entity” data display map. Both processes may involve two users—the sender, who may not need a device, and the receiver, who does have a device. The first step 902 is for the receiver to launch the application. If the receiver is a “public entity” data display, the application launched may be a professional grade in a relevant industry (i.e., law, health, education/employment, or food service). The sender may then take a face scan (step 904) and optionally enter a PIN (step 906) to log into his/her checking vault. The sender selects which data to send (step 908, if C2C transfer) or display (step 910, if “public entity” transfer) and presses done (or a similar command). The application then automatically logs the user's profile out (step 912) or logs the file displayed out after a timer (step 914, if “Public Entity”). Transfer of a contact-info card may be done quicker, easier, and without risking having one's PIN stolen by just a face scan and a two digit number (or other quick secondary password or identification metric) that is both faster and separate to the public checking vault PIN.

In one embodiment, the contact card includes the user's full name (mandatory), their profile picture so that users can now remember all entries in their phone (mandatory), their cell phone number (mandatory), their home or work number (optional), their email address (optional), their nickname (optional), their one-line personal background (optional), their favorite quote (optional), a personalized background design (optional), their address (optional), their employer and occupation (optional), and their one-line list of interests (optional). It may be mandatory for all users to have at least one contact-info card, but users are welcome to have more than one (i.e., one for personal acquaintances, one for business associates). The sending of a contact-info card may prompt a recipient to send one in exchange. When the transfer is made, the system may store all received contacts in the user's cloud profile and also may automatically integrate them into the user's smartphone address book. Using geo-coding technology, the new contact input listing may also be tagged with a GPS location of the contact transfer (i.e., a bar, office, school, or street).

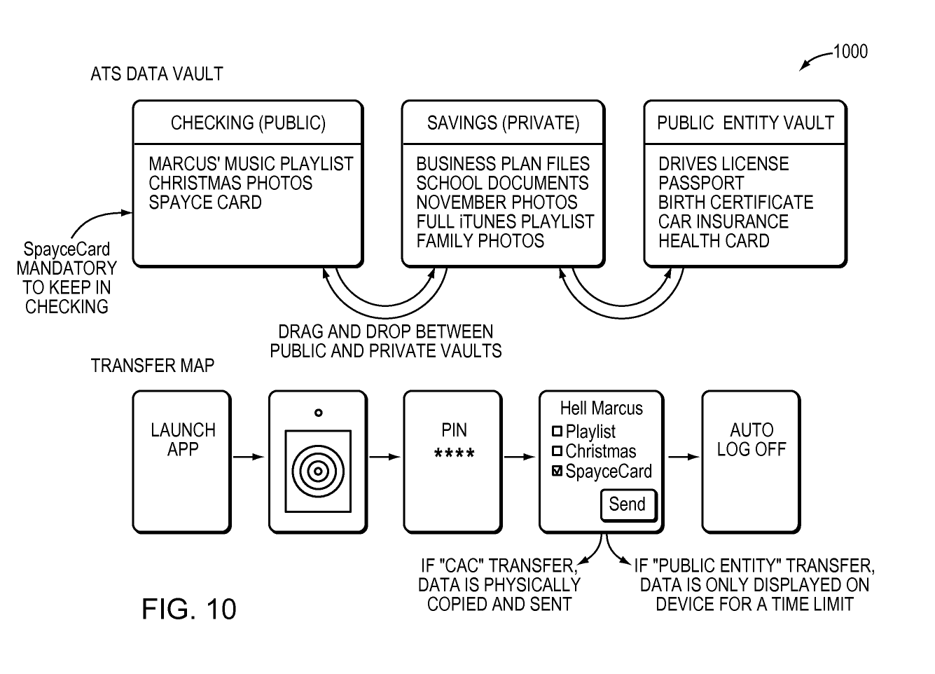

FIG. 10 illustrates one embodiment 1000 of a data vault and data transfer process. Users may drag and drop files from a private savings vault to a public checking vault to ensure the files appear when, e.g., the user is logged in on a friend's device. A minimum of one contact-info card may be present in the checking vault to allow for quick and easy contact exchange. Users may also upload identification documents for public entities and move them from the savings vault to the public entity vault. When a user is identified via a face-PIN (or any other identification embodiment) on a law application, health application, education/employment application, and/or food-service application, one or more of the relevant documents in the public entity vault may be available for the user to choose to display. Files may only be displayed on a public entity application (i.e., not physically copied and transferred like in the C2C application) and may be automatically logged out on a timer.

“C2C data” transfers refer to sharing a file with the recipient by being uploaded to the recipient's cloud via the sharer's launched application. The file, unlike a “public entity” transfer, may be downloaded and saved to the smartphone's hard drive. The infrastructure for face data transfers may include a network between a face profile in the cloud and a device. The device may be a smartphone, tablet, laptop, or desktop computer with external webcam. The network may operate as if two devices are present, through the identification of the sender via facial recognition. The login for the application may require a username and password, a fingerprint scan on a touch screen, a facial scan followed by PIN, a multiple-second facial video (to test live image), or any other such methods of identification. Any individual (e.g., a user's friend, acquaintance, colleague, peer, associate, or stranger) who has a device (e.g., a smartphone or tablet with built-in webcam) may receive data transferred by face by the user. Users may upload all of their documents and media files to their profile in the cloud for easy and fast data transfer from their face to a recipient's smartphone or tablet. Both the sender and the recipient may receive a digital overview of the transfer that is stored in their respective transfer history tab on their online profiles that details the full transfer and includes all relevant information.

In order to transfer data, a user may log into a recipient's smartphone that has the application launched. The sender may log in by taking a facial scan using the recipient's camera phone and entering his or her PIN; the sender may then select which files to transfer from his or her online storage vault. After the transfer takes place, the user's profile may be logged off automatically; and the recipient's application, however, may remain launched. The facial scan may be taken by the recipient by pointing the phone at the user or by the user by holding the phone and taking the scan independently.

The online storage vault may include both a “public entity” portal and a C2C portal. Each portal contains its own checking data account and a savings data account. The files may include, for example, a user's driver's license, passport, registration, insurance, health card, medical records file, and/or official transcript (among other items); these items may be designated to the “public entity” portal and may be accessed only by logging onto a recipient's industry-specific application. All other non-identity-specific files, such as music, videos, pictures, documents, and/or contacts (among other items) may be designated to the C2C portal and may be accessed by logging on to any recipient's consumer application. The C2C checking data account may be used to drag and drop specific files from a user's savings data account so that the files appear upon public login on a recipient's smartphone device application. All files in a user's checking data account may be accessible for instant display upon public login.

Public entities, such as law-enforcement agencies and hospitals/clinics may be designated using special applications that provide a unique data reception service to the (e.g.) officer and doctor. The special application may be purchased under a set number of downloads from the website that correlates to the number of doctors or officers who work at the location. The application may also or in addition be downloaded upon the presentation of a uniquely generated code that expires after one-time download use. “Public entity” recipients may also be, for example, company HR departments or interviewers/employers of companies signed on to the platform, as well as admissions departments of universities and their interviewers/counselors.

In one embodiment, the public entity may access different user files based on the type of entity. For example, a police officer may access only a user's driver's license, car registration, car insurance, birth certificate, and/or passport while a doctor may access a user's health card, health insurance, and/or medical records file (encrypted and uploaded by an accredited physician). In another embodiment, hospitals and doctors may use specialized devices that can access a person's health card (and only his health card) without the input of a PIN, if the user configures this setting on his online profile. With regard to human resource departments and university admissions departments, interviewers, employers, and counselors may access only a user's resume, official transcript (encrypted and uploaded by an accredited institution), official test scores (encrypted and uploaded by the test company), and recommendation letters. With regard to bars, clubs, lounges, and restaurants, the bouncer, server, or bartender may access only a user's driver's license or one official digital page of their passport.

In another embodiment, the entity may access the user's files for only a predetermined amount of time. The predetermined time may be set at different values for different types of public entities: for example, the time may be set at fifteen minutes for a police officer or 60 minutes for a doctor or other health-care worker. For other public entities, such as human-resources departments, there may be no predetermined time placed on how long the files that are selected by the sender are displayed on the recipient's device, as the files will be automatically downloadable. For still other public entities, such as those regulating age-restricted events, the predetermined time may be only one minute.

Users may upload their driver's license (and other vehicle documents like registration and insurance) to their profile in the cloud, for easy and fast data transfer to (e.g.) a police officer's smartphone or tablet. Users may also upload their health card to their profile in the cloud through the same process. A physician may also securely upload a user's encrypted medical file to the user's profile in the cloud. The medical file may not be displayed online or ever accessed by the user but may appear as a data file option to send when a user logs into a physician's smartphone application. Colleges and institutions of higher learning may upload encrypted official transcripts to a user's profile in the cloud so that a user can transfer not only his resume, but also his academic transcript to an employer at an interview within seconds. Users may upload their “public entity” documents and information cards by taking a picture of each with their smartphone while the application is launched. The picture may be taken on their smartphone. The application may instantly upload the image to the user's profile in the cloud and parse it (using, e.g., optical-character recognition). The parsing process may include finding and selecting text and other specifically identifiable information on the item to reformat as digital print in a digital template. In one embodiment, the system receives the image in a back-end subset parsing area of the online database. It extracts the text and other specifically identifiable features of the uploaded image and conveys them in digital form. The digital form may be standard textual list form, digital document/visual card reconstruction form, or a unique combination of the two. When the image has been parsed and reformatted in digital form on the back-end, both the initial image and the digital rendering (or just the digital rendering) may be sent to the user's data savings account as one item.

In order to send a “public entity” data file, a user may log into a smartphone belonging to a third party (e.g., a police officer, physician, or employer) and select which file to display. When the third party asks for identification, a user may, for example, take a facial scan using the officer's camera phone, enter his or her PIN, and select which identification document(s) to display on the third party's smartphone screen. The facial scan may be taken by the third party by pointing the phone at the user or by the user by holding the phone and taking the scan independently. The user may enter a PIN, password, or generated code to verify his or her identity after the facial scan. The user's “public entity” code-PIN may be different than the user's face payment code-PIN, as a security measure.

The recipient of a “public entity” data file may have the designated application launched, and the data file options that are presented to the user upon login to display may be dependent on the industry designation of the application that is launched. For example, a user that logs into a police officer's smartphone may select only from the files that appear related to driving (e.g., a driver's license, car insurance document, or passport). The system may recognize the application industry designation and may not display other files related to health or academics as options to be transferred. As the term is used herein, a “public entity” transfer refers to displaying a file on the recipient's smartphone for a specified amount of time before logging the viewer out. This embodiment may differ from a C2C data transfer, which actually shares the full file from a profile to a smartphone device and uploads it to the recipient's cloud and/or hard drive. Under a “public entity” transfer, no files may be uploaded to the recipient's cloud, or downloaded/saved to the phone hard drive, as the display takes place on the application only.

In one embodiment, when a person with special privileges and/or needs (e.g., a doctor) needs to know personal information of a user (e.g., health information of a patient who is unconscious or who does not have a wallet on his/her person), the doctor may use the application on his or her smartphone to take a facial scan of the patient and pull up his or her uploaded digital health card without the user's input. The doctor may have access only to the health card and/or the medical records file (nothing more), and this unauthorized no-PIN access of data is only available for doctors via the physician-specific industry application. The health card and/or medical records may be sent in a health insurance portability and accountability act (HIPAA)-compliant data format. For an unconscious user under the physician-access method, the physician may wait for the match through a longer lead time caused by an unreduced user pool (e.g., 10-20 seconds) or can manually enter the user's city based on (e.g.) another identification card found on his person. In one embodiment, the user may opt in or out of the automatic physician access system on his/her online profile. The user may continue this free service but may wish to designate the requirement of a PIN to be independently entered in order for a physician to access this data.

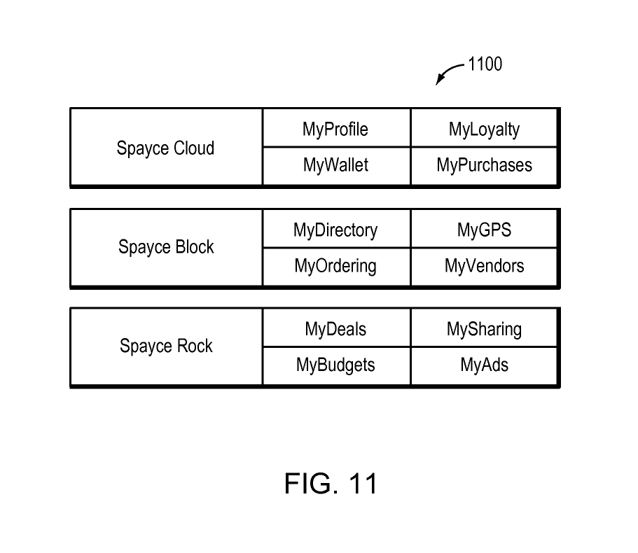

FIG. 11 is a screen shot of a user profile 1100. The user's purchases may be reported in a “my purchases” tab; this tab may be accessed at any time online or through the user's smartphone device and may stores all past purchases across all linked credit and debit cards, with digital receipts for each. A “my vendors” tab may list all of the participating vendors by country, state, city, and neighborhood, with written descriptions, menus, photo albums, videos, reviews, and maps with real-time directions. Once a transfer is made from face to phone, the sender's profile (name and profile picture) may be saved in the recipient's smartphone app under “my contacts.” The recipient may then send data (e.g., media files, documents, and contacts) to the sender at any time by simply selecting the sender's profile and attaching the items to send. These items may then be shared with the contact and appear in his profile in the cloud, prompting him to either accept or reject the transfer. Other tabs in the user profile 1100 may be used to select or view similar features.

In one embodiment, as more sharing takes place between two contacts, both users get notifications of mutual likes and interests and get suggestions on personal data in the cloud (e.g., music, videos, pictures, or documents) that the contact would likely enjoy if shared. Transfers that are enjoyed by the recipient generate rewards points for the sender (i.e., virtual currency), which transforms from virtual currency to real cash when enough points are built.

In one embodiment, once a file or series of files have been selected by a sender and are displayed on the screen of the recipient's smartphone device, the recipient navigates between them and the other features in the application. While the files are still available (e.g., under a pre-determined display time limit), the smartphone owner may minimize them and use other features of the application, coming back to the transferred files at any time by tapping the designated tab. When the predetermined time expires, the transferred files are removed from the transfer tab and the recipient can continue to operate the industry-specific application without the transferred files accessible anymore.

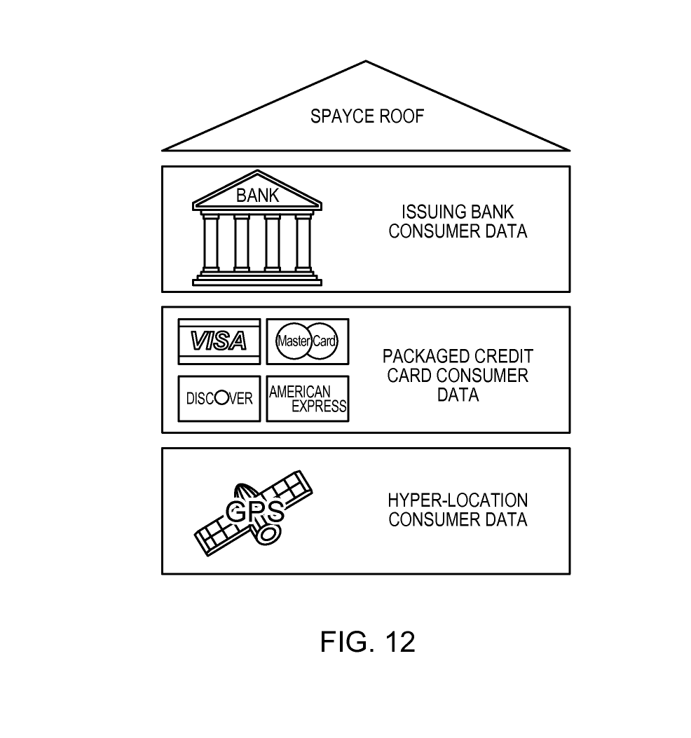

FIG. 12 illustrates three levels of consumer data made available in accordance with an embodiment of the invention. Consumer data may be generated based on, among other things, users' spending habits, purchase history, spending allocation, demographics, budgets, shopping preferences, and/or location. The system may offer suggestions to users for other stores and products they might like when a purchase is made and a digital receipt email is sent. Users may opt into a location-based advertising system to thereby receive mobile advertising based on their GPS location from their favorite merchants in the area. Users may select, for example, a number of their favorite merchants from a directory of participating merchants and get dynamic advertisements and coupons on their smartphone whenever they are in the vicinity of a store outlet. Users may gain virtual currency for opting into the location-based advertising program.

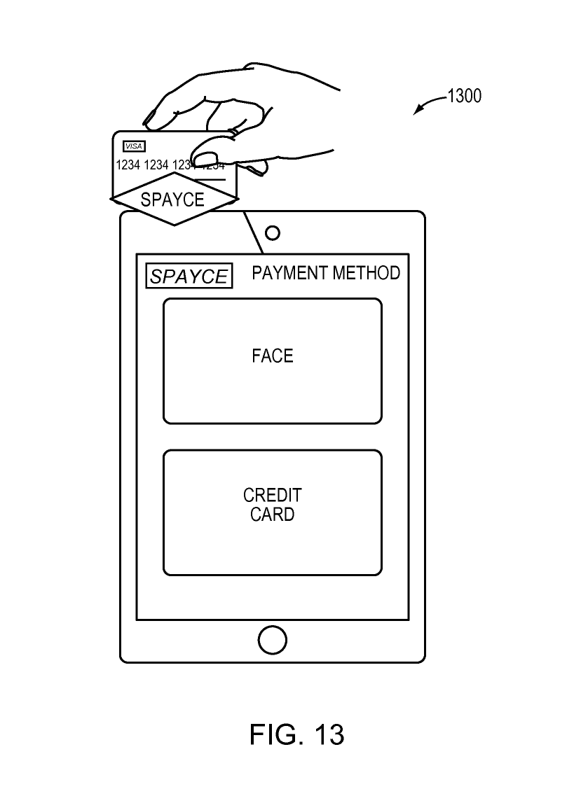

FIG. 13 illustrates a screenshot 1300 illustrating an interface for selecting a face-based or credit-card-based payment option. Whether a card is swiped or a face is scanned, as long as the consumer is a registered user and has linked that card to his or her profile, both options pull up the user's profile and display the user's name and picture on the screen. In this way, even if the user uses a credit card, the user receives the benefits of automatic loyalty, coupons, and gift card redemption among other standard face features and perks through the system.

Users may make budgets for different shopping categories (like clothes, gas, groceries, holiday shopping) and the system may track all of the user's purchases to make sure the user conforms to the budgets. When a user is about to pass a weekly, monthly, yearly, or event budget limit for a particular spending area, the system may send the user an alert (via, e.g., email) that includes an overview of the user's spending history for the relevant time period and a reminder that the allowance is about to be crossed. Families may link multiple accounts together to enable the use of family budgeting tools. Parents (or other family members) may monitor their children's (or other family member's) credit- and debit-card spending habits by designating that both parties get automatic notifications of a purchase by the latter party. The system may also track the consistency of the purchases of a user for anomalies. The system may separate repeat purchases from first-time purchases so users know exactly what they're buying and how often.

In another embodiment, users make their payment selection by saying a keyword (e.g., “VISA 1,” “MASTERCARD 2,” “Business”) and possibly another keyword representing a verification measure; the second keyword may be displayed on the screen (e.g., one of a number of random questions are displayed on the user's profile, and the user is prompted to say his or her name, postal code, number in address, area code, last four digits of a particular card, etc.).

An exemplary embodiment of a system for processing financial or other transactions using facial recognition is hereby presented. The system may include a tablet and a server and communicate with a user, credit-card company, and acquirer bank. The server is connected to a database of profiles (containing, e.g., pictures, names, PINs, no-match codes, financial information, uploaded digital coupons, uploaded gift cards, and/or loyalty for each vendor). The tablet captures a live image of the user's face and relays the picture, price, and item keywords purchased to the server; the server matches the picture, pulls up an associated user profile, and sends data back to the tablet (e.g., user name, picture, payment options, loyalty (via vendor keyword match), and/or coupons (through vendor keyword match and product keyword match of all previously uploaded coupons)). After payment has been selected, loyalty and coupons may be automatically factored into the price (and the change may be displayed on the tablet on, e.g., a “processing” screen). Payment is encrypted and sent from tablet to the server, and then from the server to the credit card company and ultimately to the acquirer bank for instant verification.

The tablet may be used first by a cashier (or other merchant) and then also used by the customer; in other embodiments, the user and cashier may have separate tablets (connected to a POS system by a wired or wireless connection). The POS system may be an existing vendor or merchant system and/or incorporated into the merchant's tablet. The tablet may take a single photo of the user's face or a series of frames of photos (e.g., multiple camera photos or frames of video). The different photos may be averaged or otherwise combined to improve the quality of the image; in other embodiments, a subset of the photos may be selected. The tablet may receive, from the POS system or other system, a digital receipt, price information, vendor keywords, and/or product keywords. The tablet may transmit, to the server, the photo or photos, PIN, digital receipt, vendor or product keywords, and/or price.

In one embodiment, the server receives data comprising one or more photos from the tablet. The photo is run against a database of pictures to find a match using any technique known in the art; the present invention is not limited to any particular method of facial matching. If an exact match is found, the server identifies the associated user account (and may confirm the account with the PIN). If the server is unable to identify an exact match, it accesses the plurality of matching profiles (in accordance with a threshold level of matching, for example, 30% certainty) and selects the matching profile based on the PIN. The matching profile may include vendor and/or product keywords; the server compares these profile keywords with any keywords transmitted from the table. Matching vendor keywords may be used to accrue loyalty points or to redeem gift cards; matching product keywords may be used to apply uploaded coupons.

The server may send any one of the matching name, photo, payment options, loyalty, coupons, and/or gift cards to the tablet. The tablet may display some or all of this information so that they user may verify their correct facial/PIN match, select payment options, and/or view discounts or coupons associated with the purchase. The user selects a payment option and transmits the selection to the server (along with transaction information, such as an encrypted credit or debit card number and any coupons or discounts). The server sends the price of the transaction (with any applicable discounts applied) and the encrypted payment information to the credit card company for approval and receives an approval or rejection in return; this decision is transmitted back to the tablet.

The tablet, upon receipt of the decision, may display an approval or rejection message in response. The tablet may also allow the user to choose between a digital or paper receipt; if the user selects a digital receipt, the server may then send the digital receipt to the tablet; information in the receipt (e.g., product name or price) may be stored on the user's profile and/or displayed thereon. If a user has no associated profile, the digital receipt may be sent to a specified email address.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for facial-recognition-based financial transactions, the system comprising:
a client computing device configured for executing instructions on a processor, the instructions comprising:
i. receiving information related to a product or service;
ii. receiving a facial scan and PIN of a user; and
iii. transmitting the information, facial scan, and PIN to a server computing device; and
a server computing device configured for executing instructions on a processor, the instructions comprising:
i. receiving the information, facial scan, and PIN from the client computing device;
ii. selecting a subset of user profiles from a pool of user profiles based on a location of the user;
iii. matching the facial scan to one or more facial pictures associated with the subset of user profiles;
iv. optionally selecting one of the one or more facial pictures based on the PIN and PINs associated with the subset of user profiles; and
v. sending information related to the user profile associated with the selected facial picture and payment information to the client computing device.

2. The system of claim 1, wherein the client computing device is further configured for receiving the information sent from the server, displaying payment information to the user, and transmitting a payment selection to the server computing device.

3. The system of claim 2, wherein the server computing device is further configured for receiving the payment selection.

4. The system of claim 1, wherein the client computing device captures a plurality of frames of video and wherein the server matches the frames of video to one or more live images associated with the subset of user profiles.

5. The system of claim 1, wherein the subset of user profiles is selected based on the user's city or ZIP code.

6. The system of claim 1, wherein the facial scan is matched to the one or more facial pictures based on a minimum threshold.

7. The system of claim 1, wherein the user accrues loyalty points associated with the financial transaction.

8. The system of claim 7, wherein the loyalty points are translated into a virtual currency.

9. The system of claim 1, wherein the payment information comprises a plurality of credit or debit cards ranked in order of user preference or available balance.

10. The system of claim 1, wherein the client computing device is further configured for sending data associated with the user to a profile associated with the user.

11. The system of claim 1, further comprising a third-party client computing device, wherein the client computing device is configured to send the data to the third-party computing device based on a captured facial scan of a third-party user of the third-party client computing device.

12. The system of claim 1, further comprising a third-party client computing device, wherein a third party captures a facial scan of the user using the third-party client computing device and accesses, based on the facial scan, personal information regarding the user for a limited amount of time.

13. A method for facial-recognition-based financial transactions, the method comprising:
receiving, at a client computing device, information related to a product or service;
receiving, at the client computing device, a facial scan and PIN of a user; and
transmitting the information, facial scan, and PIN from the client computing device to a server computing device; and
receiving, at the server computing device, the information, facial scan, and PIN from the client computing device;
selecting a subset of user profiles from a pool of user profiles based on a location of the user;
matching the facial scan to one or more facial pictures associated with the subset of user profiles;
optionally selecting one of the one or more facial pictures based on the PIN and PINs associated with the subset of user profiles; and
sending information related to the user profile associated with the selected facial picture and payment information to the client computing device.

14. The method of claim 12, further comprising receiving the information sent from the server, displaying payment information to the user, and transmitting a payment selection to the server computing device.

15. The method of claim 13, wherein the server computing device is further configured for receiving the payment selection.

16. The method of claim 12, wherein the client computing device captures a plurality of frames of video and wherein the server matches the frames of video to one or more live images associated with the subset of user profiles.

17. The method of claim 12, wherein the subset of user profiles is selected based on the user's city or ZIP code.

18. The method of claim 12, wherein the facial scan is matched to the one or more facial pictures based on a minimum threshold.

19. The method of claim 12, wherein the user accrues loyalty points associated with the financial transaction.

20. The method of claim 12, wherein the loyalty points are translated into a virtual currency.

21. The method of claim 12, wherein the payment information comprises a plurality of credit or debit cards ranked in order of user preference or available balance.

22. The method of claim 12, wherein the client computing device is further configured for sending data associated with the user to a profile associated with the user.

23. The method of claim 12, further comprising sending the data from the client computing device to a third-party computing device based on a captured facial scan of a third-party user of the third-party client computing device.

24. The method of claim 12, further comprising sending personal information regarding the user to a third-party user of a third-party client computing device, wherein the third party captures a facial scan of the user using the third-party client computing device and accesses, based on the facial scan, the personal information for a limited amount of time.
